(19) United States
(12) Patent Application Publication
(10) Pub. No.: US 2004/0237105 A1
(43) Pub. Date: Nov. 25, 2004

(54) Method of managing electronic program guide, and multimedia device using the same

(75) Inventor: Hoe-seong Ha, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/847,882

(22) Filed: May 19, 2004

(30) Foreign Application Priority Data
May 19, 2003 (KR) 10-2003-0031672

(51) Int. Cl. H04N 5/445; G06F 3/00; G06F 13/00

(52) U.S. Cl. 725/44; 725/39; 725/40

(57) ABSTRACT

A method of managing an electronic program guide (EPG) and a multimedia device is provided, where the size and/or position of an EPG frame on a display, or the sizes of cells of a grid in the EPG frame, can be changed. The method of managing the EPG includes generating an EPG display frame; modifying the EPG frame; and storing the modified EGP frame. The multimedia device includes an AV decoder for receiving and separating EPG information; a storage unit for storing the EPG information and an EPG frame; an EPG control unit for generating EPG display signals and modifying the stored EPG frame; and a display for displaying an EPG. According to the invention, a user can adjust the sizes of the cells of the grid in the EPG frame, and the size and position of the EPG frame so that they are suitable for his/her preference.

### BACKGROUND OF THE INVENTION

This application is based upon and claims the benefit of priority from Korean Patent Application No. 10-2003-0031672 filed on May 19, 2003, in the Korean Intellectual Property Office, the disclosure of which is incorporated herein in its entirety by reference.

1. Field of Invention

The invention relates to an electronic program guide (EPG), and more particularly, to a method of managing an EPG, wherein a user can define the interval, size, or position of a cell of a grid in the EPG.

2. Description of the Related Art

The Korean Broadcasting System (KBS) started servicing ground wave digital broadcasting as of Nov. 5, 2001. Such ground wave digital broadcasting provides an EPG, which corresponds to a printed TV program guide available from a newspaper or magazine. The EPG can be directly displayed on a TV screen, as well as video/audio services with higher quality than existing analog broadcasting.

Digital broadcasting employs a data compression technique for compressing video and audio streams into digital information and broadcasting the digital information. Various types of system information and program information, which are required by receivers, are compressed and broadcasted according to the standards of Program and System Information Protocol (PSIP) of the Advanced Television Systems Committee (ATSC). Upon receipt, broadcasting program related information is decoded from the broadcast data (not the video and audio information) and then displayed on a screen to inform a user of program related information through an EPG.

FIG. 1 shows a flowchart illustrating the process of displaying an EPG on a TV screen according to the related art.

First, program information, provided along with video/audio signals through ground wave broadcasting or satellite broadcasting, is received and extracted (S2). The extracted program information is stored in a memory (S4). When a user wants to view TV program information while watching TV, the user manipulates buttons provided on a remote control or TV set to cause an EPG to be displayed on a TV screen (S6). Then, the program information in a text format stored in the memory, and a grid-shaped EPG frame for causing the program information to be arranged on the TV screen are retrieved (S8), so that a picture of an EPG to be displayed can be configured (S10). The configured picture of the EPG is displayed on the TV screen (S12). The user can check TV program schedules of various channels through the displayed EPG.

FIG. 2 shows a picture of an EPG displayed according to the related art.

The horizontal axis represents time information, whereas the vertical axis represents channel information. In FIG. 2, there is shown information on programs broadcasted through seven channels at 30-minute intervals from 9:00 p.m. to 11:00 p.m. A program called “Music Box” that is broadcasted on Channel 9 at 10:00 p.m. is currently highlighted in FIG. 2.

FIG. 3 shows that a cell of an EPG has been highlighted by moving a highlighting cursor, according to the related art.

A program called “NEWS” broadcasted on Channel 9 at 9:00 p.m. has been highlighted. A user can press a right direction arrow key provided on a remote control or TV set to move the highlighting cursor rightwards. The highlighting cursor is moved to the rightmost position so as to highlight a program called “Talk Show” broadcasted on Channel 9 at 11:00 p.m. Then, when the right direction arrow key is pressed again, the time range of the displayed EPG is changed to 9:30 p.m. to 11:30 p.m., and a program called “NEWS” on Channel 9 is then highlighted. Of course, it is possible to implement the EPG such that the time range thereof can be from 11:30 p.m. to 01:30 a.m. Further, up/down direction arrow keys may be pressed to move the highlighting cursor in order to highlight programs on other channels.

When a TV program is highlighted, the user can obtain more detailed information such as a synopsis and starring actors in the highlighted program and thus receive help in selecting a program that the user wants to view.

Such an EPG allows a person watching TV to know programs broadcasted on various channels at certain times without referring to a printed program guide available from a magazine or newspaper, when he/she manipulates a remote control while watching TV. In some cases, the EPG provides the person watching TV with more detailed information on a highlighted program, so that he/she receives help in selecting a desired program. That is, the EPG assists the user in promptly and conveniently checking the channel on which, and the time at which, a desired program is to be broadcasted.

However, there is a problem in that since the conventional picture of the displayed EPG described with reference to FIGS. 1 to 3 has cells of the same size used for representing times at which TV programs are to be broadcasted, cells other than a highlighted cell that the user truly considers as being important also provide the same amount of text information as the highlighted cell. Thus, in case of an EPG with cells of a fixed size, a cell that the user is interested in and the other cells that the user is not interested in are displayed in the same ratio on a screen. Therefore, there is a problem in that information that the user truly wants may be provided in a small amount in the displayed EPG, or information that the user does not want may be unnecessarily provided in a large amount.

### SUMMARY OF THE INVENTION

The invention is conceived to solve the aforementioned problems. An object of the invention is to provide a method enabling a user to modify the size of a cell of a grid in an EPG. Another object of the invention is to provide a method enabling a user to shift and/or modify the position and/or size of an EPG frame so that the user can continue to view the EPG while watching TV.

A further object of the invention is to provide a multimedia device for displaying an EGP in which a user can manage the interval, size and position of a cell of a grid.

According to one aspect of the invention for achieving the objects, there is provided a method of managing an electronic program guide (EPG), comprising generating an EPG frame; modifying the EPG frame; and storing the modified EGP frame.

The EPG frame may be modified by adjusting the sizes of cells of a grid, by adjusting the size of the EPG frame, or by adjusting the position of the EPG frame on a display screen. The EPG frame is modified when a user manipulates a remote control.

According to another aspect of the invention for achieving the objects, there is provided a multimedia device, comprising an AV decoder for receiving a signal, and separating EPG information from the received signal; a storage unit for storing the EPG information, and an EPG frame; an EPG control unit for generating EPG display signals based on the stored EPG information and EPG frame, in response to EPG control signals, and for modifying the stored EPG; and a display for displaying an EPG based on the EPG display signals. The user may issue the EPG control signals by manipulating buttons on a remote control.

### BRIEF DESCRIPTION OF THE DRAWINGS

The above and other objects, features and advantages of the invention will become apparent from the following description of exemplary embodiments given in conjunction with the accompanying drawings, in which:

FIG. 1 is a flowchart illustrating the process of displaying an EPG on a TV screen according to the related art;

FIG. 2 shows a picture of an EPG displayed according to the related art;

FIG. 3 shows that a cell of an EPG has been highlighted by moving a highlighting cursor, according to the related art;

FIG. 4 shows a block diagram of a multimedia device employing an EPG according to an embodiment of the invention;

FIG. 5 is a flowchart illustrating the process of displaying an EPG on the multimedia device according to an embodiment of the invention;

FIG. 6 shows a picture of an EPG in which cells of a grid are modified such that central cells of the grid become larger;

FIG. 7A shows movement of the highlighting cursor on the picture of the EPG in which the cells of the grid are modified such that the central cells of the grid become larger;

FIG. 7B shows that the grid is adjusted in such a manner that a cell highlighted due to the movement of the highlighting cursor becomes wider;

FIG. 8 shows an example of adjustment of the sizes of cells of a grid in an EPG;

FIG. 9 shows an example of adjustment of the size of an EPG frame; and

FIG. 10 shows a shift of an EPG frame, which has been adjusted to be smaller in size on a display screen.

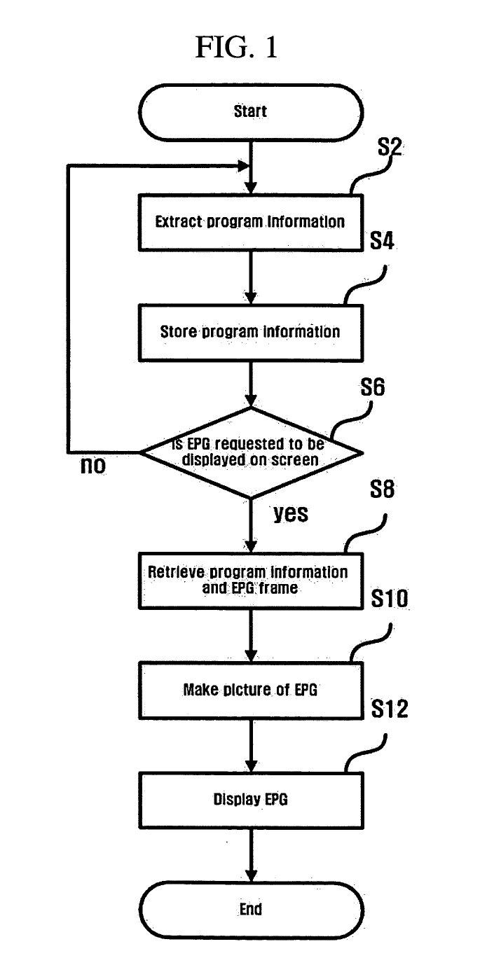

### DETAILED DESCRIPTION OF THE INVENTION

Exemplary embodiments of the invention will be described in detail below with reference to the accompanying drawings. The described exemplary embodiments are intended to assist the understanding of the invention, and are not intended to limit the scope of the invention in any way.

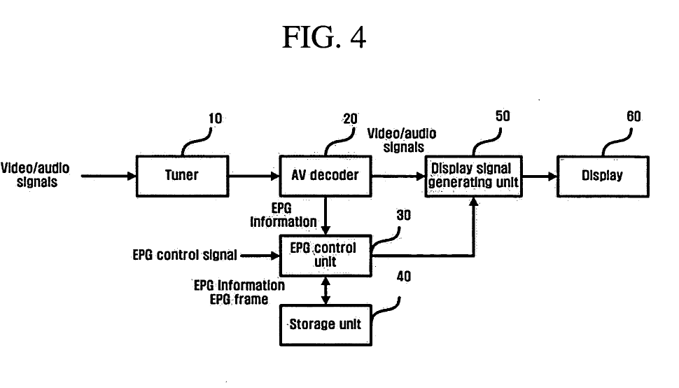

FIG. 4 shows a block diagram of a multimedia device employing an EPG according to an exemplary embodiment of the invention.

The multimedia device comprises a tuner 10 for selecting a desired channel; an AV decoder 20 for restoring video and audio data from signals received from the tuner 10; a storage unit 40 for storing program information and an EPG frame; an EPG control unit 30 for receiving EPG control signals and modifying the EPG frame; a display signal generating unit 50 for generating display signals based on EPG data received from the EPG control unit 30 and the video and audio data received from the AV decoder 20; and a display 60 for performing displaying based on the display signals received from the display signal generating unit 50.

The tuner 10 selects a signal of the desired channel among signals (e.g., radio frequency signals) input via an antenna (not shown) or a cable (not shown). The signal input via the cable or in the wireless manner further includes added signals such as synchronization signals for system control and program information for configuring an EPG, in addition to the video and audio signals.

The AV decoder 20 receives signals of a channel selected by the tuner 10, and extracts the program information as well as video and audio signals therefrom. The video and audio signals for digital broadcasting are sent after generally being encoded using a compression technique such as MPEG2 for reducing the amount of information. The AV decoder 20 decodes the video and audio signals encoded using a predetermined method to restore the video and audio data.

The EPG control unit 30 stores the program information, which is extracted by and forwarded from the AV decoder 20, in the storage unit 40. Further, when a user selects the EPG menu, the EPG control unit 30 retrieves the program information stored in the storage unit 40 and creates EPG data. The EPG data is created by the EPG control unit 30 based on the program information in a text format and an EPG frame. Then, the EPG data is sent to the display signal generating unit 50. Meanwhile, depending on the user's selection, the EPG control unit 30 modifies the interval, size or position of a cell of a grid in the EPG frame, and stores the modified EPG frame in the storage unit 40. The user may select the EPG using buttons provided on a remote control or multimedia device, and generate control signals for modifying the EPG frame.

The display signal generating unit 50 receives the digital video and audio data and EPG data, and generates display signals. The generated display signals are supplied to the display 60 to be displayed thereon. The display 60 may be, for example, a cathode ray tube (CRT) or a plasma display panel (PDP). The display signal generating unit 50 may generate the display signals only based on the EPG data without receiving the video and audio data, and vice versa. The former case may correspond to a case where a user only checks TV programs without actually watching TV or modifies the EPG frame.

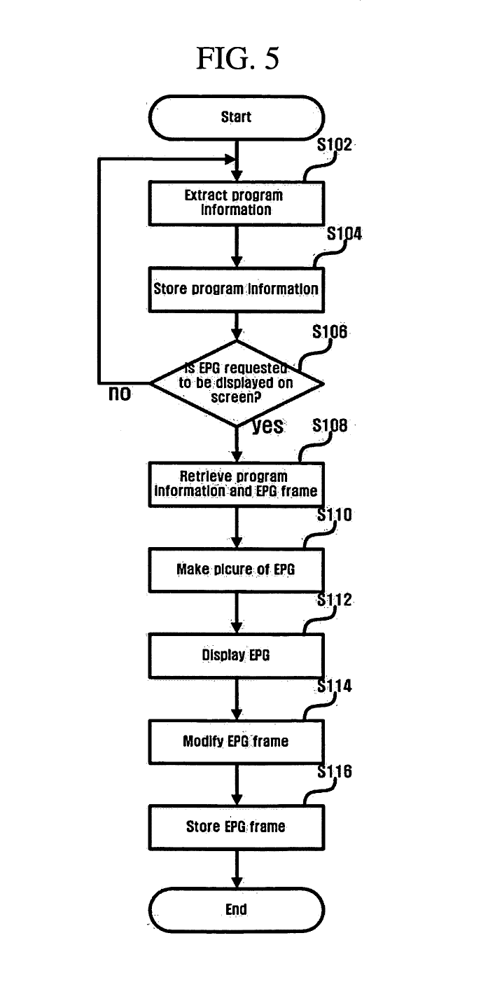

FIG. 5 is a flowchart illustrating the process of displaying an EPG on a multimedia device according to an embodiment of the invention.

To display the EPG on a screen, program information is extracted from signals input via a cable or in a wireless manner (S102). The program information is information in a text format and includes TV channels and times at which programs are to be broadcasted. The extracted program information is stored in a memory such that a user can view the EPG whenever the user wants (S104). In a case where the user selects an EPG menu using a remote control or the like to view a picture of the EPG (S106), the program information and the EGP frame stored in the memory are retrieved (S108) and used in generating EPG data for making a picture of the EPG (S110). In making the picture of the EPG, text may be adapted to the size of each cell of a grid in the EPG frame. For example, in the case of a smaller cell, the size of the text font used may be reduced to fit the sizes of the cells, or a portion of the text may be truncated. On the contrary, in case of a larger cell, the size of the text font used may be increased, or a greater amount of program information may be inserted into the cell. When the picture of the EPG is made (S110), the picture of the EPG is displayed on the display (S112). Meanwhile, the user may modify the EPG frame so that the user can conveniently view the EPG. The EPG frame may be modified by adjusting the size of a cell while maintaining the size of the EPG frame, by modifying the size of the EPG frame, or by shifting the EPG frame on the display (S114). The modification may be made by, for example, manipulating buttons on either the remote control or the multimedia device. However, the invention is not limited thereto. When the EPG frame is modified (S114), the modified EPG frame is stored to keep the modified EPG frame (S116). The invention can be implemented such that a modified EPG frame can be stored whenever the EPG frame is modified, but the invention is not limited thereto. The modified EPG frame may be stored only when the user wants to store the modified EPG frame, which also falls within the scope of the invention.

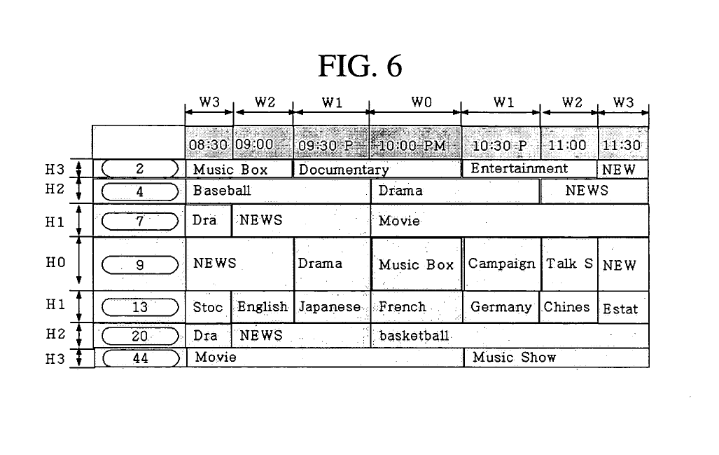

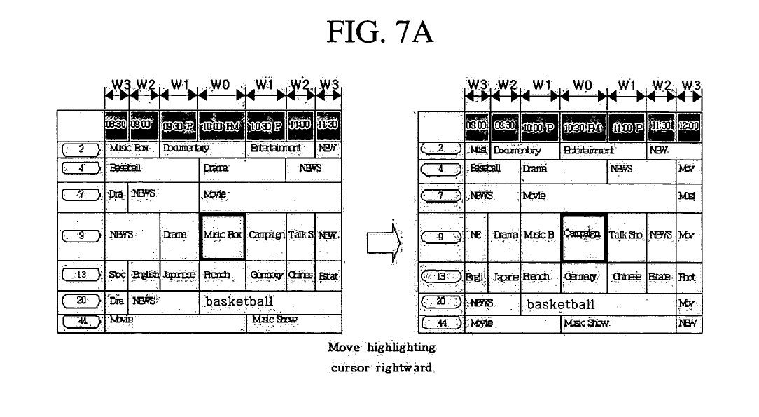

FIG. 6 shows a picture of an EPG in which cells of a grid are modified such that central cells of the grid become larger, and FIG. 7A shows movement of a highlighting cursor on the picture of the EPG in which the cells of the grid are modified such that the central cells of the grid become larger.

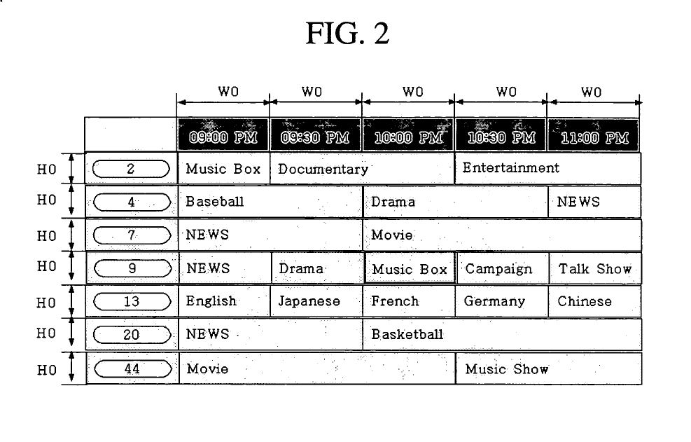

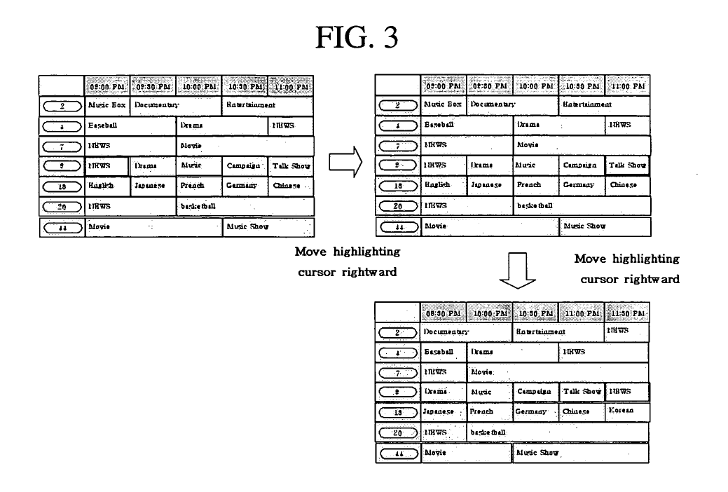

It can be seen from FIG. 6 that the central cells of the grid in the EPG become larger as compared with FIG. 2. That is, the central cells are caused to be larger in consideration of the following points: the user wants to obtain more information on programs in which the user is interested; and a quick program search can be made if the user can recognize which programs exist. In FIG. 6, for example, a program shown in a smaller cell that is to be broadcasted on Channel 9 at 11:00 p.m. has a title of “Talk S.” Although the title is displayed as “Talk S” with some text truncated, there is no significant problem in searching programs because the user can recognize it as “Talk Show.” The embodiment shown in FIG. 7A is implemented such that the highlighted program is centrally located at any time. This is to more fully display information on a program of interest. The user may want to know about the program designated only by “Talk S.” In this case, the user can select the text “Talk S” to be highlighted and then the full text “Talk Show” is provided. Referring to FIG. 7A, there is shown movement of the highlighting cursor. If the highlighting cursor is moved rightwards to the “Campaign” program from the “Music Box” program that is currently highlighted, the highlighted “Campaign” program is then located at the central portion of the EPG having cells of the largest size. It is noted that the selected and highlighted cell is always centrally located whatever program is selected.

In the meantime, according to the invention, the sizes of the cells of the grid in the EPG may be adjusted depending on the movement of the highlighting cursor, without causing the highlighted cell to be centrally located. FIG. 7B shows that the grid is adjusted in such a manner that a cell highlighted due to the movement of the highlighting cursor becomes wider. Specifically, if the highlighting cursor is moved by one cell rightwards from the cell representing the “Music Box” program broadcasted on Channel 9 at 10:00 p.m., the width of the cell representing the “Campaign” program broadcasted on Channel 9 at 10:00 p.m. increases up to W0 that is the largest width, while the width of the previously highlighted cell representing the “Music box” program decreases to W1. Thus, the title truncated like “Music B” is displayed in the cell having the width of W1 on the screen. In the foregoing, it has been described that a portion of the text is truncated in compliance with the varying cell size upon movement of the highlighting cursor. However, a method of adjusting the font size of the displayed text also falls within the scope of the invention.

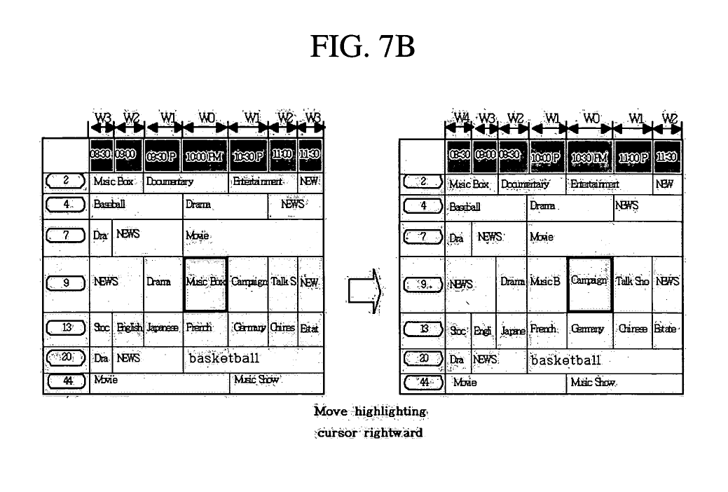

FIG. 8 shows an example of adjustment of the sizes of cells of a grid in an EPG. In FIG. 8, the horizontal axis represents time, while the vertical axis represents channels. The user can adjust the sizes of the cells by manipulating the buttons on the remote control. FIG. 8 shows an EPG frame in which individual intervals on both horizontal and vertical axes are adjusted. However, only the intervals on the horizontal axis may be adjusted. When the sizes of the cells of the grid in the EPG frame vary, the text of program information inserted into each cell may be properly adjusted so as to adapt to the varying size of the cell. For example, in case of a smaller cell, the font size of the text may decrease, or a portion of the text may be truncated.

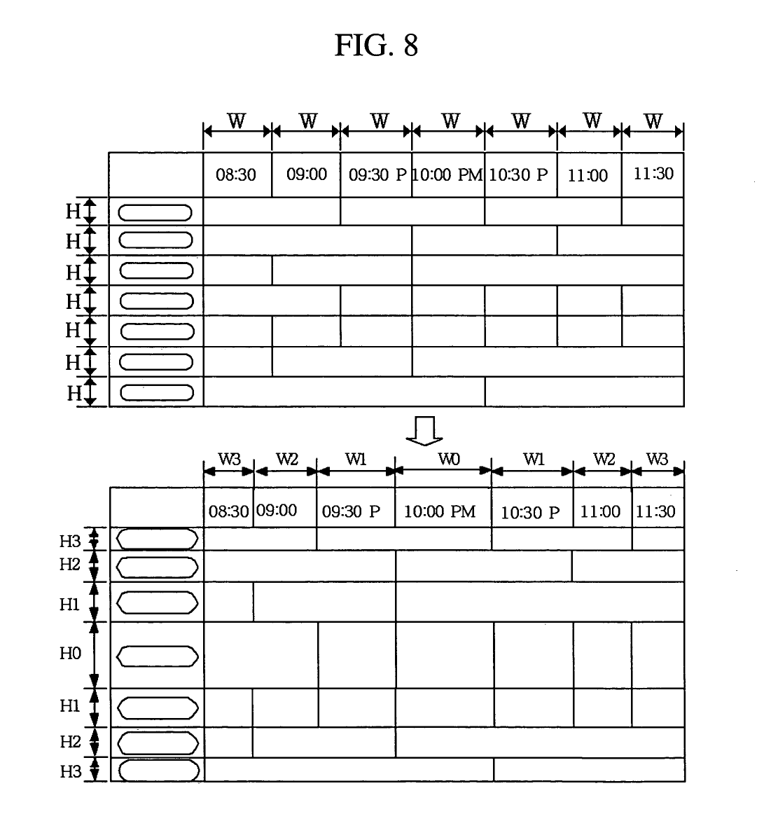

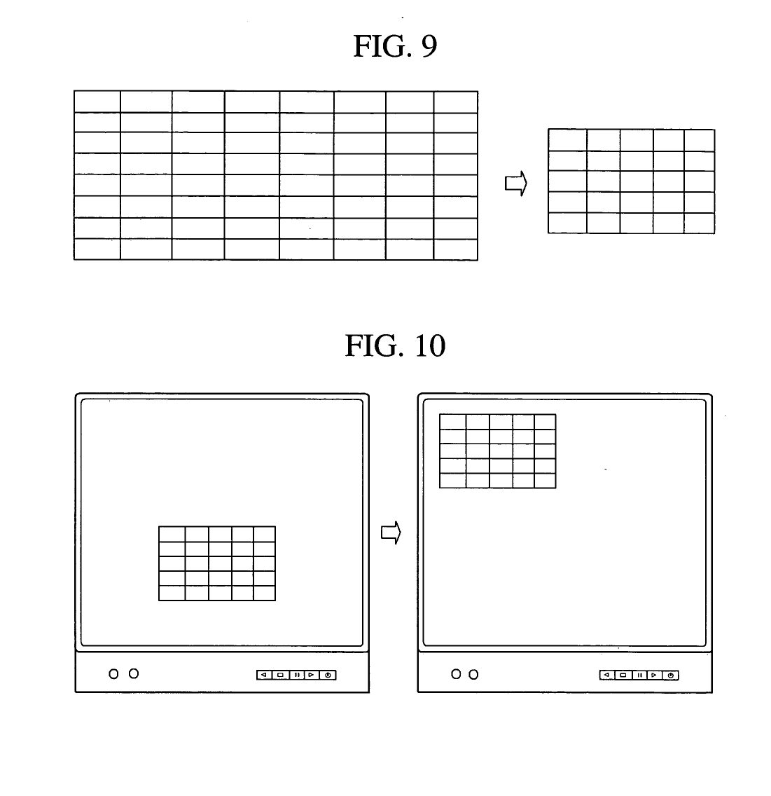

FIG. 9 shows an example of adjustment of the size of an EPG frame, and FIG. 10 shows a shift of an EPG frame, which has been adjusted to be smaller in size on the display screen.

FIG. 9 shows a decrease in the size of the EPG frame. The decrease in the size of the EPG frame may be implemented by reducing the number of cells, decreasing the sizes of the cells, or employing both of the above techniques. The text of program information may be adjusted to be adapted to the sizes of the cells. FIG. 10 shows a state where a small sized EPG frame is shifted to an upper left position of the display screen. The user can conveniently watch TV with the small sized EPG continuously displayed on the TV screen at the same time.

According to the invention described above, the sizes of the cells of the grid in the EPG frame can be adjusted so that a central portion of the EPG frame becomes larger. Further, the highlighted cell can be located centrally on the picture of the displayed EPG so that the highlighted cell can be easily viewed. In addition, the sizes of the cells can be automatically adjusted depending on the movement of the highlighting cursor. In this case, information on the highlighted program can be maximally provided to the user.

Further, according to the invention, the size and position of the EPG frame on the display can be changed. Therefore, the EPG frame may be made smaller and located at the corner of the display screen of the multimedia device. Thus, there is an advantage in that the user can check TV programs without having trouble in watching TV.

It will be understood by those skilled in the art that the invention can be implemented in other specific forms without changing the technical spirit or essential features of the invention. Therefore, it should be noted that the forgoing embodiments are merely illustrative in all aspects and are not to be construed as limiting the invention. The scope of the invention is defined by the appended claims rather than the detailed description of the invention. All changes or modifications or their equivalents made within the meanings and scope of the claims should be construed as falling within the scope of the invention.

What is claimed is:

1. A method of managing an electronic program guide (EPG), comprising:
generating an EPG frame;
modifying the EPG frame; and
storing the modified EGP frame.

2. The method of claim 1, wherein generating the grid-shaped EPG frame comprises generating EPG display signals based on EPG information and a grid-shaped EPG frame.

3. The method of claim 1, wherein modifying the EPG frame comprises changing an appearance of a grid of the EPG frame.

4. The method of claim 1, wherein modifying the EPG frame comprises adjusting a cell dimension of a first cell in a grid of the EPG frame.

5. The method of claim 3, wherein changing the appearance of a grid of the EPG frame comprises adjusting a cell dimension of a first cell in the grid.

6. The method of claim 4, wherein the cell dimension of the first cell in the grid is adjusted so that the first cell is the largest cell in the grid.

7. The method of claim 5, wherein the cell dimension of the first cell in the grid is adjusted so that the first cell is the largest cell in the grid.

8. The method of claim 4, wherein modifying the EPG frame further comprises adjusting a cell dimension of a second cell in the grid of the EPG frame, wherein the second cell neighbors the first cell.

9. The method of claim 8, wherein the cell dimension of the second cell is adjusted to allow the first cell to be the largest cell in the grid.

10. The method of claim 4, wherein the first cell corresponds to a cell highlighted by a user, and the first cell is always located as the central cell of the grid.

11. The method of claim 8, wherein the first cell corresponds to a cell highlighted by a user, and the first cell is always located as the central cell of the grid.

12. The method of claim 1, wherein modifying the EPG frame comprises adjusting a frame dimension of the EPG frame.

13. The method of claim 4, wherein modifying the EPG frame further comprises adjusting a frame dimension of the EPG frame.

14. The method of claim 1, wherein modifying the EPG frame comprises adjusting the position thereof on a display screen.

15. The method of claim 4, wherein modifying the EPG frame further comprises adjusting the position thereof on a display screen.

16. The method of claim 1, wherein the EPG frame is modified in response to signals issued when a user manipulates buttons on a remote control.

17. The method of claim 1, wherein the EPG frame is modified in response to signals issued when a user manipulates buttons on a multimedia device.

18. A multimedia device, comprising:
an AV decoder for receiving a signal and separating EPG information from the received signal;
a storage unit for storing the EPG information and an EPG frame;
an EPG control unit for generating EPG display signals based on the stored EPG information and EPG frame, in response to EPG control signals, and for modifying the stored EPG frame; and
a display for displaying an EPG based on the EPG display signals.

19. The multimedia device of claim 18, wherein the EPG control unit modifies the EPG frame by changing an appearance of a grid of the EPG frame.

20. The multimedia device of claim 18, wherein the EPG control signals are issued when a user manipulates buttons on a remote control.

21. The multimedia device of claim 18, wherein the EPG control signals are issued when a user manipulates buttons on the multimedia device.
